(19) United States
(12) Patent Application Publication
(10) Pub. No.: US 2013/0230663 A1
(43) Pub. Date: Sep. 5, 2013

(54) PROTECTIVE FILM FORMING METHOD, AND SURFACE FLATTENING METHOD

(71) Applicant: ULVAC, INC., Chigasaki-shi (JP)

(72) Inventors: Daisuke OMORI, Chigasaki-shi (JP); Kazuya UCHIDA, Chigasaki-shi (JP)

(73) Assignee: ULVAC, Inc., Chigasaki-shi (JP)

(21) Appl. No.: 13/777,310

(22) Filed: Feb. 26, 2013

Related U.S. Application Data
(63) Continuation of application No. PCT/JP2011/069583, filed on Aug. 30, 2011.

(30) Foreign Application Priority Data
Sep. 3, 2010 (JP) 2010-198026

(51) Int. Cl. B05D 3/06

(52) U.S. Cl. CPC B05D 3/067
USPC 427/509

(57) ABSTRACT

A method for flattening a surface of a substrate in which a film formation surface has a recess and a convex and a method for forming a protective film by using a photo-curable organic thin film material are provided. A gas of an organic thin film material having photocurability is liquefied on the surface of a substrate having the recess and the convex and a liquid organic layer is grown on the surface of the substrate (first liquid layer growing step T₁); and the growth is terminated when a liquid organic layer having a flat surface is formed (first growth termination step T₂).

### TECHNICAL FIELD

The present invention generally relates to a technology for forming a protective film on a surface of a substrate having a recess and a convex, and more particularly to a technology for flattening the recess and the convex surface to form a protective film on the surface.

### BACKGROUND ART

Plasma display panels and organic EL display devices or the like have a natural tendency to deteriorate due to moisture, and a protective film that naturally does not transmit water (water resistance) is formed in a region where a display element is formed.

A ceramic thin film attracts attention in water resistance, but since the surface on which the display element is formed has the recess and the convex, a film thickness is thin in a step portion, and only a protective film which is poor in water resistance can be obtained.

If water resistance is to be improved by thickening the ceramic thin film thickness, a crack can be easily generated in the ceramic protective film formed thick; and moreover, the thick ceramic thin film can easily peel off; and thus, water resistance cannot be improved.

The following references are references relating to steam barriers.

### CITATION LIST

### Patent Literature

PTL 1: Japanese Unexamined Patent Application Publication No. 2009-237202

PTL 2: Japanese Unexamined Patent Application Publication No. 2008-149710

### DISCLOSURE OF THE INVENTION

### Problems to be Solved by the Invention

The object of the present invention is to provide a technology for forming a protective film having a ceramic thin film on a substrate having a rugged portion on a surface.

### Means for Solving the Problems

The inventors of the present invention have invented a method whereby a protective film having a ceramic thin film requires flattening of the recess and the convex on the surface where the ceramic thin film is to be formed.

However, when an organic thin film material having photocurablility applied on a substrate was irradiated with ultraviolet rays and curing was attempted, the ultraviolet rays were decayed in the atmosphere and could not sufficiently cure the organic thin film material, while in a vacuum ambience, evaporation of a liquid-state organic thin film material occurred, and a flat surface shape could not be obtained.

Moreover, in order not to expose an object to be formed to moisture, the protective film is preferably formed without being exposed to the atmosphere after a previous step of processing the surface of the object to be formed is finished. On the other hand, there is a problem of a ceramic thin film having a large film thickness.

The present invention solves the above-described problems. The present invention provides a protective film forming method for forming a protective film on a film formation surface of a substrate in which the film formation surface has the recess and the convex, comprising,a first liquid layer growing step of arranging the substrate in a vacuum ambience, evaporating a first organic thin film material having photocurability so as to generate a first steam of the first organic thin film material, bringing the first steam into contact with the film formation surface of the substrate in a first film formation pressure lower than an atmospheric pressure so as to liquefy the first steam on the film formation surface, growing a first liquid organic layer composed of the first organic thin film material on the film formation surface, and filling an inside of the recess portion of the recess and the convex on the film formation surface with the first liquid organic layer; a first growth termination step of terminating growth of the first liquid organic layer after a surface of the first liquid organic layer reaches a height equal to a height of an upper part of the recess and the convex on the film formation surface; a flattened layer forming step of irradiating the first liquid organic layer with light in a pressure not less than a first curing pressure higher than the first film formation pressure so as to cure the first liquid organic layer and to form a flattened layer; and a first ceramic layer forming step of forming a first ceramic layer composed of ceramics on the flattened layer.

In the protective film forming method of the present invention, a temperature of the first liquid organic layer raised when an ultraviolet rays are irradiated in the flattened layer forming step is measured in advance as a first heating temperature; and the first curing pressure is set to a first steam pressure which is a steam pressure when the first organic thin film material is placed in the vacuum ambience and raised to the first heating temperature.

In the protective film forming method of the present invention, in the first liquid layer growing step, the first liquid organic layer is made to grow while the substrate is cooled to a temperature of at most zero degree (0° C.).

In the protective film forming method of the present invention, the first liquid layer growing step, the first growth termination step, and the flattened layer forming step are performed in the same first vacuum chamber.

The protective film forming method of the present invention, includes, after the first ceramic layer forming step, a second liquid layer growing step of arranging the substrate with the first ceramic layer formed on a surface thereof in the vacuum ambience, evaporating a second organic thin film material having photocurability so as to generate a second steam, bringing the second steam into contact with the film formation surface of the substrate in a second film formation pressure lower than the atmospheric pressure so as to liquefy the second steam on the first ceramic layer, and growing a second liquid organic layer composed of the second organic thin film material on the first ceramic layer; a buffer layer forming step of irradiating the second liquid organic layer with light in a pressure not less than a second curing pressure higher than the second film formation pressure so as to cure the second liquid organic layer and to form a buffer layer; and a second ceramic layer forming step of forming a second ceramic layer on a surface of the buffer layer.

In the protective film forming method of the present invention, a temperature of the second liquid organic layer raised when the ultraviolet rays are irradiated in the buffer layer forming step is measured in advance as a second heating temperature, and the second curing pressure is set to a second steam pressure which is a steam pressure when the second organic thin film material is placed in the vacuum ambience and raised to the second heating temperature.

In the protective film forming method of the present invention, in the second liquid layer growing step, the second liquid organic layer is made to grow while the substrate is cooled to a temperature of at most zero degree (0° C.).

In the protective film forming method of the present invention, the second liquid layer growing step and the buffer layer forming step are performed in the same second vacuum chamber.

In the protective film forming method of the present invention, the first organic thin film material and the second organic thin film material have the same composition.

In the protective film forming method of the present invention, the first and second ceramic layers have the same composition.

In the protective film forming method of the present invention, the first and second ceramic layers are Al₂O₃ layers.

A surface flattening method of the present invention for flattening a surface of a substrate in which a film formation surface has the recess and the convex, includes, a first liquid layer growing step of arranging the substrate in a vacuum ambience, evaporating a first organic thin film material having photocurability so as to generate a first steam of the first organic thin film material, bringing the first steam into contact with the film formation surface of the substrate in a first film formation pressure lower than an atmospheric pressure so as to liquefy the first steam on the film formation surface, growing a first liquid organic layer composed of the first organic thin film material on the film formation surface, and filling an inside of the recess portion of the recess and the convex on the film formation surface with the first liquid organic layer; a first growth termination step of terminating growth of the first liquid organic layer after the surface of the first liquid organic layer becomes a height equal to a height of an upper part of the recess and the convex on the film formation surface; and a flattened layer forming step of irradiating the first liquid organic layer with light in a pressure not less than a first curing pressure higher than the first film formation pressure so as to cure the first liquid organic layer and to form a flattened layer.

In the surface flattening method of the present invention, a temperature of the first liquid organic layer raised when the ultraviolet rays are irradiated in the flattened layer forming step is measured in advance as a first heating temperature, a first steam pressure which is a steam pressure when the first organic thin film material is placed in the vacuum ambience and raised to the first heating temperature is measured, and the first curing pressure is set to the first steam pressure.

In the surface flattening method of the present invention, in the first liquid layer growing step, the first liquid organic layer is made to grow while the substrate is cooled to a temperature of at most zero degree (0° C.).

In the surface flattening method of the present invention, the first liquid layer growing step, the first growth termination step, and the flattened layer forming step are performed in the same vacuum chamber.

In the vacuum ambience, a technology of adhesing a transparent base plate and a polarizer using an ultraviolet curing resin as an adhesive has been disclosed (Japanese Unexamined Patent Application Publication No. 2009-237202). The Japanese Unexamined Patent Application Publication No. 2009-237202 does not describe that the adhesive layer evaporates and decreases when the adhesive layer is cured by the ultraviolet rays in the vacuum ambience. In the Japanese Unexamined Patent Application Publication No. 2009-237202, the adhesive layer is sandwiched by a substrate 71 and a polarizer 6, and evaporation of the adhesive is restrained or the thickness of the adhesive layer is large, and evaporation does not seem to matter.

In general, a boiling point of a substance is lower if a pressure of an ambient pressure is low compared to if it is high; and thus, when an organic compound in a liquid state is arranged in a vacuum chamber, if the vacuum chamber is evacuated and brought into a vacuum ambience, evaporation occurs at a temperature lower than a boiling point in the atmosphere.

At that time, if the inside of the vacuum chamber is brought to a pressure not less than a steam pressure of the organic compound at the temperature by introduction of a purge gas or the like, it is known that an evaporation speed is decelerated, and a decrease of the organic compound due to evaporation becomes smaller.

On the other hand, when the organic thin film material is irradiated with ultraviolet rays, the temperature of the organic thin film material is raised, and the evaporation speed is accelerated along with the irradiation of the ultraviolet rays. Thus, by measuring the steam pressure of the organic thin film material in the vacuum ambience in advance by using a temperature raised when the organic thin film material is cured by the ultraviolet rays as a heating temperature, by introducing a purge gas not reacting with the organic thin film material into the vacuum chamber during actual irradiation of the ultraviolet rays, and by bringing the inside of the vacuum chamber into a pressure smaller than the steam pressure when the temperature of the organic thin film material is raised to the heating temperature, the evaporation speed can be largely lowered, and a decrease amount of the organic thin film material can be reduced.

### Effect of the Invention

Since the evaporation amount of the organic thin film material can be reduced, a gas of the photocurable organic thin film material can be made to adhere to a rugged portion on the substrate surface so as to be liquefied and to form a first liquid organic layer, the rugged portion is buried by the first liquid organic layer and cured so that the surface can be flattened.

Consequently, by forming the flattened layer by curing the first liquid organic layer, a first ceramic layer can be formed on the flattened layer.

Moreover, by making the gas of the second organic thin film material having photocurability adhere to the surface of the first ceramic layer so as to form a second liquid organic layer, and a buffer layer with a flat surface can also be formed by photo-curing.

As described above, by arranging a buffer layer between the ceramic layers and by forming a protective film by laminating a plurality of the ceramic layers, the ceramic layer can be made multiple, and a film thickness per layer can be made thin while water resistance is ensured; and thus, the ceramic layer does not peel off or a crack does not occur.

Since the ceramic layer is formed on a flat surface, the film thickness is made uniform.

### BRIEF DESCRIPTION OF THE DRAWINGS

FIG. 1 is a flowchart illustrating a procedure of an example of a protective film forming method.

FIG. 2A is a sectional view for explaining an example of an organic thin film forming chamber and FIG. 2B is a sectional view for explaining an organic thin film forming chamber of another example.

FIG. 3 is a schematic figure of a vacuum film forming device.

FIGS. 4A to 4H are figures for explaining an example of a forming procedure of the protective film forming method.

### BEST MODES FOR CARRYING OUT THE INVENTION

<Device>

An embodiment of the present invention will be described below.

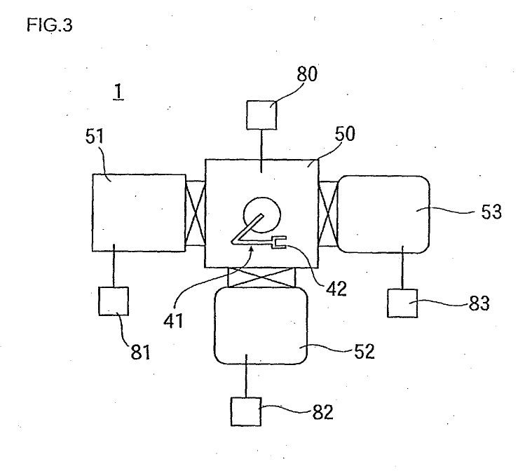

FIG. 3 is a vacuum film forming device 1 of an example used for the present invention, and it has a conveyance chamber 50, a carrying in/out chamber 51, an organic thin film forming chamber 52, and an inorganic thin film forming chamber 53.

The carrying in/out chamber 51, the organic thin film forming chamber 52, and the inorganic thin film forming chamber 53 are connected to the conveyance chamber 50, respectively.

Vacuum evacuation devices 80 to 83 are connected, respectively, to the chambers 50 to 53 and configured to individually evacuate the inside of each of the chambers 50 to 53 so as to make it a vacuum ambience.

Inside the conveyance chamber 50, a substrate conveying robot 41 is arranged, and it is so configured that a substrate which is an object to be processed is placed on a hand 42 of the substrate conveying robot 41 and passed through the conveyance chamber 50 and can move between each of the chambers 51 to 53.

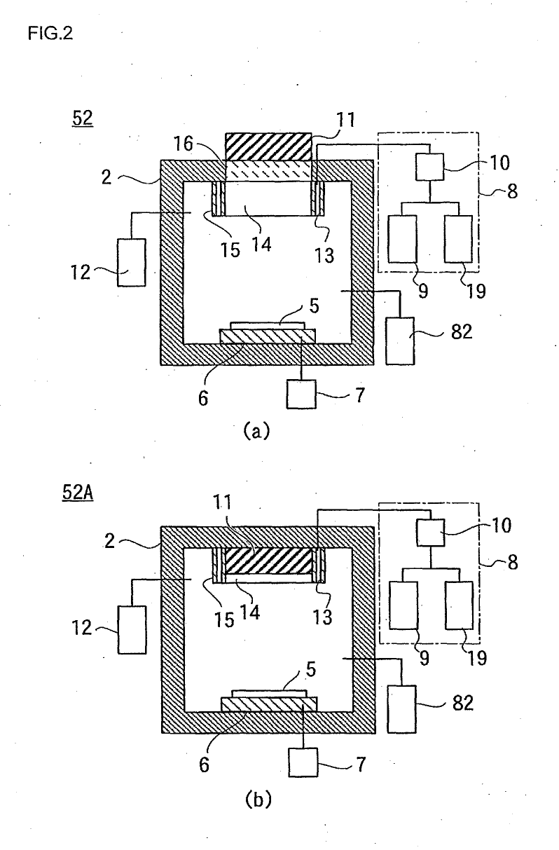

FIGS. 2A and 2B are figures for explaining an inside of the organic thin film forming chamber 52.

The organic thin film forming chamber 52 has a vacuum chamber 2, and a sample base 6 and a material gas introducing device 15 composed of an annular pipe having a hollow inside arranged inside the vacuum chamber 2, respectively.

A window 16 is provided on a ceiling of the vacuum chamber 2; and ultraviolet rays irradiating means 11 is arranged above the window 16 outside of the vacuum chamber 2.

The ultraviolet rays irradiating means 11 is configured to generate ultraviolet rays and to emit the ultraviolet rays toward the window 16.

This window 16 is formed of a material such as quartz transmitting ultraviolet rays; and the ultraviolet rays emitted from the ultraviolet rays irradiating means 11 transmits through the window 16 and is irradiated to the inside of the vacuum chamber 2.

A central portion of the annular pipe of the material gas introducing device 15 is a through hole 14 composed of a space surrounded by the annular pipe and configured to transmit light; and the material gas introducing device 15 is arranged inside the vacuum chamber 2 so that the through hole 14 is located right below the window 16.

The sample base 6 is located below the window 16; and the ultraviolet rays transmitted through the window 16 passes through the through hole 14 of the material gas introducing device 15 and is irradiated onto the sample base 6.

Outside the vacuum chamber 2, a material gas supply unit 8 and a purge gas supply unit 12 are arranged.

The material gas introducing device 15 is connected to the material gas supply unit 8.

The material gas supply unit 8 has a liquid storing device 19, an evaporator 10 and a carrier gas supply device 9; and a liquid-state organic thin film material is arranged in the liquid storing device 19.

The organic thin film material in the liquid storing device 19 is supplied to the evaporator 10; and the evaporator is configured to evaporate the liquid-state organic thin film material and generate an organic thin film material gas.

The carrier gas supply device 9 is connected to the evaporator 10; and a carrier gas is supplied into the evaporator 10.

The evaporator 10 is connected to the material gas introducing device 15; and while the carrier gas passes through the evaporator 10 and is supplied from the carrier gas supply device 9 into the material gas introducing device 15, the organic thin film material gas is mixed with the carrier gas in the evaporator 10 and moves from the inside of the evaporator 10 to the material gas introducing device 15 along with movement of the carrier gas.

In the hollow inside portion of the material gas introducing device 15, a plurality of outlets 13 is provided on the lower end thereof, and the hollow inside is configured to connect with an internal atmosphere in the vacuum chamber 2.

The evaporator 10 is connected to the hollow inside portion of the material gas introducing device 15; and when the organic thin film material gas and the carrier gas are supplied to the inside hollow portion from the material gas supply system 8, the supplied organic thin film material gas and the carrier gas fill the inside hollow portion of the material gas introducing device 15 and are then discharged into the vacuum chamber 2 brought into the vacuum ambience from the outlet 13. Here, the outlet 13 is directed toward the sample base 6, and the organic thin film material gas and the carrier gas are discharged toward the sample base 6.

On the other hand, the purge gas supply unit 12 is connected to the inside of the vacuum chamber 2, and the inside of the vacuum chamber 2 is configured such that a purge gas (a rare gas such as a N₂ gas, Ar or the like) can be introduced by the purge gas supply unit 12. The inside of the vacuum chamber 2 can be brought to a desired pressure lower than the atmospheric pressure by the purge gas.

<Protective Film Forming Method>

A protective film forming method of the present invention using the above-described vacuum film forming device 1 hereinafter described.

The protective film forming method of the present invention is a method of forming a protective film on a substrate having the recess and the convex on the surface and includes a surface flattening step, a first ceramic layer forming step, a second liquid layer growing step, a buffer layer forming step, and a second ceramic layer forming step.

A vacuum valve between the conveyance chamber 50 and the carrying-in/out chamber 51 is closed, the evacuating devices 80, 82, and 83 are operated, the conveyance chamber 50, the organic thin film forming chamber 52, and the inorganic thin film forming chamber 53 are brought into a vacuum ambience in advance, the substrate is arranged in the carrying-in/out chamber 51 in the atmosphere, the inside of the carrying-in/out chamber 51 is brought into a vacuum ambience and then, the inside of the carrying-in/out chamber 51 and the inside of the conveyance chamber 50 are connected to each other, and the substrate is carried into the vacuum chamber 2 in the organic thin film forming chamber 52 by the substrate conveying robot 41.

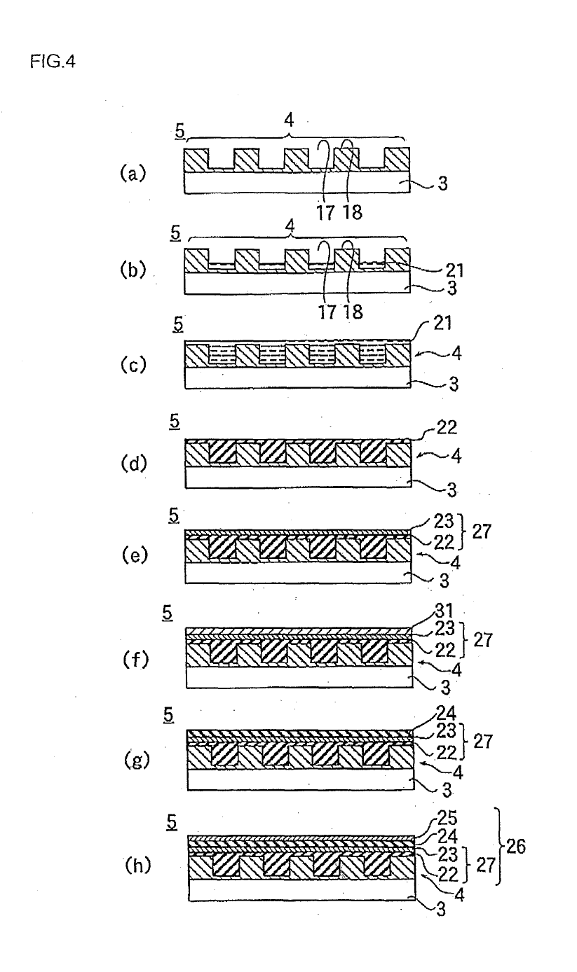

Reference numeral 5 in FIG. 2 denotes the substrate carried into the vacuum chamber 2 and arranged on the sample base 6, and the substrate 5 has, as illustrated in FIG. 4A which is its partial sectional view, a substrate portion 3 composed of a glass substrate and a rugged portion 4 composed of a pixel region formed on the substrate portion 3. The rugged portion 4 has a convex potion 18 and a recess portion 17 having a depth of several μm or more.

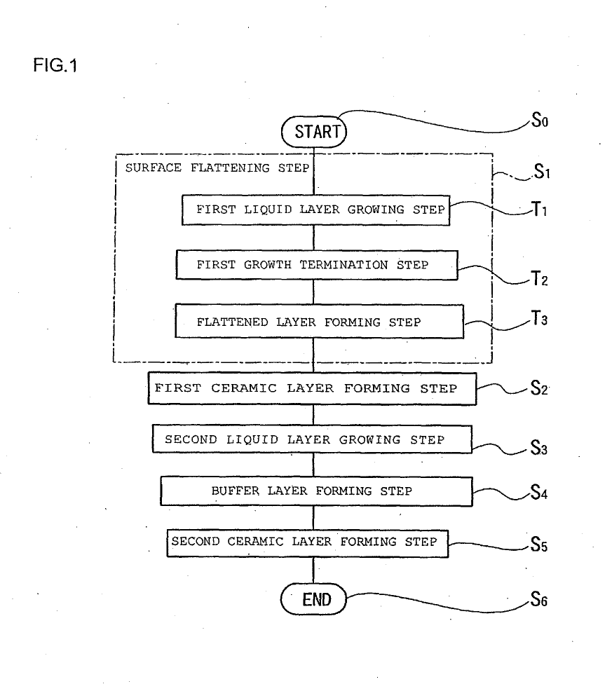

FIG. 1 is a flowchart illustrating a procedure of an example of the protective film forming method; and FIGS. 4A to 4H are figures for explaining an example of a forming procedure of the protective film forming method. Explanation will be made by referring to FIG. 1 and FIGS. 4A to 4H.

First, a film forming step is started (S₀).

In this example, the first and second organic thin film forming materials are liquid-state photo-curable organic thin film materials, and the first organic thin film material (A-NPG: Shin-Nakamura Chemical Co., Ltd.) is an acrylic resin and is arranged in the liquid storing device 19.

<Surface Flattening Step S₁>

Inside the sample base 6 in FIG. 2, a circulation path connected to the cooling device 7 is arranged, and the inside of the vacuum chamber 2 is evacuated to at most 1 Pa, and a cooled medium is made to flow through the circulation path by the cooling device 7 so as to cool the substrate 5 on the sample base 6.

The inside of the vacuum chamber 2 has been evacuated, and after the substrate 5 is cooled to a temperature below zero (−15° C., here), the evaporated first organic thin film material is discharged together with the carrier gas to the vacuum ambience toward the surface of the substrate 5 on the sample base 6 from the material gas introducing device 15.

The pressure of the vacuum ambience in which the substrate 5 is arranged is maintained at the first film formation pressure (90 Pa, here) which is a low pressure set in advance; and the temperature of the substrate 5 is cooled to a temperature equal to or below a liquefaction temperature of the first organic thin film material gas. The first organic thin film material gas brought into contact with the substrate 5 surface is liquefied on the surface of the rugged portion 4 of the substrate 5; and growth of a first liquid organic layer composed of the liquid first organic thin film material is started on the substrate 5 surface (first liquid layer growing step T₁).

The first organic thin film material gas is liquefied at a position inside and outside of the recess portion 17 of the rugged portion 4; and the liquid-state first organic thin film material gas generated outside the recess portion 17 flows into the recess portion 17. Reference numeral 21 in FIG. 4B denotes the first liquid organic layer composed of the first organic thin film material liquefied in the recess portion 17.

The first liquid organic layer 21 is also formed outside the recess portion 17, but due to inflow into the recess portion 17, the film thickness of the first liquid organic layer 21 outside the recess portion 17 does not grow, and the film thickness in the recess portion 17 increases.

The first liquid organic layer 21 in the recess portion 17 grows; and the first liquid organic layer 21 fills from the shallow recess portion 17 in the plurality of recess portions 17 which are deep and shallow. Liquefaction of the first organic thin film material also progresses on the surface of the first liquid organic layer 21 having filled the shallow recess portion 17; and when the shallow recess portion 17 is filled with the first liquid organic layer 21, the liquefied first organic thin film material flows out to the outside of the shallow recess portion 17 and flows into the deep recess portion 17.

As described above, the deep recess portion 17 is also filled with the first liquid organic layer 21, and each recess portion 17 is filled with the first liquid organic layer 21, and when the surface of the first liquid organic layer 21 reaches the height equal to that of the upper end of each rugged portion 4 and after, the discharge of the first organic thin film material gas and the carrier gas from the outlet 13 is stopped, and the growth of the first liquid organic layer 21 is terminated (first growth termination step T₂).

FIG. 4C is a state in which the first liquid organic layer 21 is formed up to the position higher than the upper end of the rugged portion 4; and when the formation of this first liquid organic layer 21 is terminated, the upper end of the rugged portion 4 of the substrate 5 is located at a height equal to the surface of the first liquid organic layer 21 or below that, and the convex portion 18 is also covered by the first liquid organic layer 21.

Next, the flattened layer forming step will be described. After the first liquid organic layer 21 in FIG. 4C is formed, and the first organic thin film material gas and the carrier gas are evacuated from the inside of the vacuum chamber 2 and the pressure in the vacuum chamber 2 is lowered, by supplying the purge gas into the vacuum chamber 2 from the purge gas supply system 12 so as to raise the pressure of the vacuum ambience in which the substrate 5 is arranged, and when the pressure reaches a pressure not less than the first curing pressure set in advance, emission of the ultraviolet rays is started. The first curing pressure is higher than the first film formation pressure and lower than the atmospheric pressure.

This first curing pressure is a pressure measured in advance; and when the first liquid organic layer 21 is irradiated with the ultraviolet rays in the flattening step, a temperature (180° C., for example) to which the first liquid organic layer 21 is raised is measured in advance as a first heating temperature, and the first curing pressure is set at a steam pressure of the first organic thin film material (a saturated steam pressure in the vacuum ambience for this first organic thin film material, it is 100 Pa at 180° C.) when the temperature of the first organic thin film material is raised to the first heating temperature in the vacuum ambience.

Since the first curing pressure is higher than the pressure when the first liquid organic layer 21 is grown, the purge gas is introduced in order to raise the pressure higher than the first film formation pressure. If the inside of the vacuum chamber 2 is in the pressure atmosphere not less than the first curing pressure, steam generated from the liquid-state first organic thin film material is less.

The first organic thin film material used in the present invention is photo-curable; and here in particular, an ultraviolet-curable resin is used. When the first liquid organic layer 21 is irradiated with the ultraviolet rays, the first organic thin film material constituting the first liquid organic layer 21 starts a curing reaction.

While curing of the first liquid organic layer 21 is progressing, the first liquid organic layer 21 is irradiated with the ultraviolet rays; and as illustrated in FIG. 4D, when a flattened layer 22 composed of the cured first liquid organic layer 21 and having a flat surface is formed, emission of the ultraviolet rays is finished (flattened layer forming step T₃).

Then, the surface flattening step S₁ is finished, and the substrate 5 is carried out of the vacuum chamber 2.

<First Ceramic Layer Forming Step S₂>

The substrate 5 on which the flattened layer 22 is formed is carried into the inorganic thin film forming chamber 53, a ceramic object to be processed (here, Al₂O₃ target) in the inorganic thin film forming chamber 53 is subjected to sputtering by the sputtering method; and as illustrated in FIG. 4E, a first ceramic layer 23 composed of a ceramic thin film (Al₂O₃ thin film, here) is formed on the surface of the flattened layer 22.

This first ceramic layer 23 is formed on the surface of the flattened layer 22 having a flat surface; and the flattened layer 22 is covered by the first ceramic layer 23 having a uniform thickness. Regarding the film thickness of the ceramic thin film, the thicker the thickness is, the higher the barrier performance against moisture becomes. However, since a crack can easily occur, this first ceramic layer 23 and each ceramic layer which will be described later are formed having a thin thickness to a degree that a crack does not occur; and at this stage, a first protective film 27 is formed.

<Second Liquid Layer Growing Step S₃>

After the first ceramic layer 23 is formed in a second liquid layer growing step S₃ and a buffer layer forming step S₄, as illustrated in FIG. 4G, a buffer layer 24 softer than the first ceramic layer 23 is formed on the surface of the first ceramic layer 23.

Here, the substrate 5 on which the first ceramic layer 23 is formed is sent back from inside the inorganic thin film forming chamber 53 into the organic thin film forming chamber 52, and steam of the second organic thin film material which is the same compound as the first organic thin film material is generated in the same procedure as the first liquid layer growing step T₁; the steam is introduced into the organic thin film forming chamber 52; the steam of the second organic thin film material is brought into contact with the surface of the first ceramic layer 23 while the substrate 5 is being cooled; and as illustrated in FIG. 4F, a photo-curable second liquid organic layer 31 composed of a liquid-state second organic thin film material is made to grow to a predetermined film thickness on the surface of the first ceramic layer 23.

<Buffer Layer Forming Step S₄>

Then, the purge gas is introduced into the vacuum chamber 2, in a state where the vacuum ambience in which the substrate 5 is placed is brought to a pressure not less than a second curing pressure which is the same as the first curing pressure; the second liquid organic layer 31 is irradiated with the ultraviolet rays so as to cure the second liquid organic layer 31; and as illustrated in FIG. 4G, the buffer layer 24 is formed on the surface of the first ceramic layer 23.

This second curing pressure is a pressure measured in advance; and when the second liquid organic layer 31 is irradiated with the ultraviolet rays in the buffer layer forming step S₄, a temperature to which the second liquid organic layer 31 is raised is measured as a second heating temperature, and the second curing pressure is set to a steam pressure of the second organic thin film material when the temperature of the second organic thin film material is raised to the second heating temperature in the vacuum ambience.

Since the second curing pressure is higher than the second film formation pressure when the second liquid organic layer 31 is grown, the purge gas is introduced in order to raise the pressure higher than the second film formation pressure.

Here, since the buffer layer 24 is an organic thin film having the same composition as that of the flattened layer 22 and since the first organic thin film material and the second organic thin film material are the same compound, the first curing pressure and the second curing pressure have the same value.

The second liquid layer growing step S₃ and the buffer layer forming step S₄ may be performed in a vacuum chamber different from that of the first liquid layer growing step T₁ or the flattened layer forming step T₃.

### <Second Ceramic Layer Forming Step S₅>

Subsequently, on the surface of the buffer layer 24, as illustrated in FIG. 4H, a second ceramic layer 25 is formed.

Here, the substrate 5 is moved into the inorganic thin film forming chamber 53 from the organic thin film forming chamber 52, and the second ceramic layer 25 composed of ceramics (here, Al₂O₃) having the same composition and in the same procedure as those in formation of the first ceramic layer 23 is formed.

The second ceramic layer 25 is formed having a thickness to a degree that a crack does not occur.

As described above, a protective film 26 composed of the flattened layer 22, the first ceramic layer 23, the buffer layer 24, and the second ceramic layer 25 is formed on the surface of the rugged portion 4.

The above-described protective film 26 is configured to have a total film thickness of the first ceramic layer 23 and the second ceramic layer 25 not less than a film thickness that water permeation can be sufficiently prevented by the ceramic layers.

In the above example, the buffer layer 24 is formed by curing the second liquid organic layer 31 after it is formed by the same step as that of the flattened layer 22, but since the substrate 5 has no difference in level surface formed by the surface flattening step and the first ceramic layer 23 surface is also flat, the buffer layer 24 can be formed by other methods (such as, deposition or the like). In such a case, since the organic thin film is softer than the ceramic layers, it is necessary for the buffer layer 24 to be an organic thin film and not to be a photo-curable resin thin film. Reference numeral 52A in FIG. 2 illustrates another example of the organic thin film forming chamber. As illustrated in FIG. 2, in 52A, the ultraviolet rays irradiating means 11 is arranged in the through hole 14 formed of a space surrounded by the annular pipe of the material gas introducing device 15 and is located inside the vacuum chamber 2. When the ultraviolet rays are emitted from the ultraviolet rays irradiating means 11, the ultraviolet rays reach the sample base 6. The window 16 is not installed in the organic thin film forming chamber 52A. Other portions corresponding to those in the organic thin film forming chamber 52 are given the same reference numerals.

In this organic thin film forming chamber 52A, since the ultraviolet rays do not pass through the atmosphere, an attenuation rate is small.

### EXPLANATION OF REFERENCE NUMERALS

1 vacuum film forming device
2 vacuum chamber
3 substrate portion
4 rugged portion
5 substrate
6 sample base
7 cooling device
9 carrier gas supply device
10 evaporator
11 ultraviolet rays irradiating means
12 purge gas supply system
13 outlet
14 through hole
15 material gas introducing device
16 window
17 recess portion
18 convex portion
21 first liquid organic layer
22 flattened layer
23 first ceramic layer
24 buffer layer
25 second ceramic layer
26 protective film
41 substrate conveying robot
50 conveyance chamber
51 carrying-in/out chamber
52 organic thin film forming chamber
53 inorganic thin film forming chamber
80 to 83 vacuum evacuation device

1. A protective film forming method for forming a protective film on a film formation surface of a substrate in which the film formation surface has a recess and a convex, comprising:
a first liquid layer growing step of arranging the substrate in a vacuum ambience, evaporating a first organic thin film material having photocurability so as to generate a first steam of the first organic thin film material, bringing the first steam into contact with the film formation surface of the substrate in a first film formation pressure lower than an atmospheric pressure so as to liquefy the first steam on the film formation surface, growing a first liquid organic layer composed of the first organic thin film material on the film formation surface, and filling an inside of a recess portion of the recess and the convex on the film formation surface with the first liquid organic layer;
a first growth termination step of terminating growth of the first liquid organic layer after a surface of the first liquid organic layer reaches a height equal to a height of an upper part of the recess and the convex on the film formation surface;
a flattened layer forming step of irradiating the first liquid organic layer with ultraviolet rays in a pressure not less than a first curing pressure higher than the first film formation pressure so as to cure the first liquid organic layer and to form a flattened layer; and
a first ceramic layer forming step of forming a first ceramic layer composed of ceramics on the flattened layer.

2. The protective film forming method according to claim 1,
wherein a temperature of the first liquid organic layer raised when the ultraviolet rays are irradiated in the flattened layer forming step is measured in advance as a first heating temperature, and
wherein the first curing pressure is set to a first steam pressure which is a steam pressure when the first organic thin film material is placed in the vacuum ambience and raised to the first heating temperature.

3. The protective film forming method according to claim 1, wherein
in the first liquid layer growing step, the first liquid organic layer is made to grow while the substrate is cooled to a temperature of at most zero degree (0° C.).

4. The protective film forming method according to claim 1, wherein
the first liquid layer growing step, the first growth termination step, and the flattened layer forming step are performed in a same first vacuum chamber.

5. The protective film forming method according to claim 1, comprising, after the first ceramic layer forming step:
a second liquid layer growing step of arranging the substrate with the first ceramic layer formed on a surface thereof in the vacuum ambience, evaporating a second organic thin film material having photocurability so as to generate a second steam, bringing the second steam into contact with the film formation surface of the substrate in a second film formation pressure lower than the atmospheric pressure so as to liquefy the second steam on the first ceramic layer, and growing a second liquid organic layer composed of the second organic thin film material on the first ceramic layer;
a buffer layer forming step of irradiating the second liquid organic layer with the ultraviolet rays in a pressure not less than a second curing pressure higher than the second film formation pressure so as to cure the second liquid organic layer and to form a buffer layer; and
a second ceramic layer forming step of forming a second ceramic layer on a surface of the buffer layer.

6. The protective film forming method according to claim 5,
wherein a temperature of the second liquid organic layer raised when the ultraviolet rays are irradiated in the buffer layer forming step is measured in advance as a second heating temperature, and
wherein the second curing pressure is set to a second steam pressure which is a steam pressure when the second organic thin film material is placed in the vacuum ambience and raised to the second heating temperature.

7. The protective film forming method according to claim 5, wherein
in the second liquid layer growing step, the second liquid organic layer is made to grow while the substrate is cooled to a temperature of at most zero degree (0° C.).

8. The protective film forming method according to claim 5, wherein
the second liquid layer growing step and the buffer layer forming step are performed in the same second vacuum chamber.

9. The protective film forming method according to claim 5, wherein
the first organic thin film material and the second organic thin film material have the same composition.

10. The protective film forming method according to claim 5 wherein
the first and second ceramic layers have the same composition.

11. The protective film forming method according to claim 10, wherein
the first and second ceramic layers are Al₂O₃ layers.

12. A surface flattening method for flattening a surface of a substrate in which a film formation surface has the recess and the convex, comprising:
a first liquid layer growing step of arranging the substrate in a vacuum ambience, evaporating a first organic thin film material having photocurability so as to generate a first steam of the first organic thin film material, bringing the first steam into contact with the film formation surface of the substrate in a first film formation pressure lower than an atmospheric pressure so as to liquefy the first steam on the film formation surface, growing a first liquid organic layer composed of the first organic thin film material on the film formation surface, and filling an inside of the recess portion of the the recess and the convex on the film formation surface with the first liquid organic layer;
a first growth termination step of terminating growth of the first liquid organic layer after the surface of the first liquid organic layer becomes a height equal to a height of an upper part of the recess and the convex on the film formation surface; and
a flattened layer forming step of irradiating the first liquid organic layer with the ultraviolet rays in a pressure not less than a first curing pressure higher than the first film formation pressure so as to cure the first liquid organic layer and to form a flattened layer.

13. The surface flattening method according to claim 12,
wherein a temperature of the first liquid organic layer raised when the ultraviolet rays are irradiated in the flattened layer forming step is measured in advance as a first heating temperature,
wherein a first steam pressure which is a steam pressure when the first organic thin film material is placed in the vacuum ambience and raised to the first heating temperature is measured; and
wherein the first curing pressure is set to the first steam pressure.

14. The surface flattening method according to claim 12, wherein
in the first liquid layer growing step, the first liquid organic layer is made to grow while the substrate is cooled to a temperature of at most zero degree (0° C.).

15. The surface flattening method according to claim 12, wherein
the first liquid layer growing step, the first growth termination step, and the flattened layer forming step are performed in a same vacuum chamber.
